(19) United States
(12) Patent Application Publication
(10) Pub. No.: US 2019/0114723 A1
(43) Pub. Date: Apr. 18, 2019

(54) MOBILE APPLICATION FOR FACILITATING IN-PERSON SOCIAL INTRODUCTIONS AMONG OTHER USERS

(71) Applicant: Gaurav Tiwari, Hillsborough, NJ (US)

(72) Inventor: Gaurav Tiwari, Hillsborough, NJ (US)

(21) Appl. No.: 15/785,674

(22) Filed: Oct. 17, 2017

(51) Int. Cl. G06Q 50/00; G06F 21/62; G06Q 30/04

(52) U.S. Cl. CPC G06Q 50/01; G06F 21/31; G06Q 30/04; G06F 21/629

(57) ABSTRACT

A mobile application and computer-implemented method for facilitating in-person social introductions among other users that include logging into the application, accessing a map showing the location of the user and member locations, entering a member location to determine which other users are present at the member location, viewing other member information on a handheld device, communicating with at least one other user to make an in-person face-to-face meeting with the other user, and meeting the other user face-to-face. Invoices are generated and sent to member locations based on the amount of time a user is present at the member location.

### TECHNICAL FIELD

The present disclosure relates generally to mobile applications. More specifically, the present disclosure relates to mobile applications that provide information to a user on a handheld device, upon entering a member location, regarding other users of the mobile application that are physically located at the same member location as the user so as to facilitate communication, such as a face-to-face interaction, between the user and the at least one other user.

### BACKGROUND

In today's society, many people, adults and children both, use social networking sites to socially interact with “friends.” Seventy-six percent (76%) of American adults online use social networking sites such as Facebook, Instagram, Twitter, LinkedIn, and Pintrest, as of July 2015, up from twenty-six percent (26%) in 2008. These percentages have only gone up in recent years. There is even a greater percentage of children that use these social networking sites. On social media sites like these, users may develop biographical profiles, communicate with friends and strangers, do research, and share thoughts, photos, music, links, and more.

Proponents of social networking sites like these say that the online communities promote increased interaction with friends and family. They also say that these sites offer teachers, librarians and students valuable access to educational support and materials. Further, proponents of these sites say that they facilitate political change and also disseminate useful information rapidly.

However, opponents of these types of social networking sites say that these sites prevent face-to-face communication. They also say that these sites cause people to waste time on frivolous activities. Further, opponents of these types of social networking sites say that they alter brains and behavior making users more prone to ADHD. They also say that these sites expose users to predators that may cause physical harm to the users or their property, like burglars.

In all, these social networking sites are not in fact “social” as these sites have caused face-to-face communication to decrease dramatically. People are interacting using these sites but are not socially interacting face-to-face. When users that have used these sites for a number of years do end up in a face-to-face interaction, the interaction is usually awkward and their communication skills have decreased. What is needed is a mobile application that users can use to facilitate face-to face interactions with other users, which are likely strangers to one another, so that users can meet and interact face-to-face with different users at various locations that are also members of this application.

### SUMMARY

An exemplary embodiment includes a computer-implemented method using a handheld device for facilitating a user of an application to interact face-to-face with another user of the application at a member location. This method includes the step of logging into an application from a handheld device having a display screen. This method also includes the step of transmitting user information to a database upon logging in to the application. While using the application, the method also includes the step of travelling to a location where at least one member location appears on the display screen when the user is in a selected proximity to the at least one member location. Further, while using the application, the method includes the step of entering into one of the member locations. Upon entering the member location, the method also includes transmitting other user information that are using the application and which are present at the same member location as the user to the display screen. While using the application, the method includes the step of allowing information on other users that are using the application and which are present at the same member location as the user to appear on the display screen. While using the application, the method includes communicating with at least one other user having information displayed on the display screen to determine whether the user and the at least one other user wants to meet and communicate face-to-face at the member location, the communicating being performed using the handheld device of the user and the handheld device of the at least one other user. The method further includes the step of physically meeting the at least one other user for a face-to-face meeting.

Another exemplary embodiment includes a computer program product for facilitating a user to interact face-to-face with another user at a member location. This product includes a computer-readable medium that includes a login module for allowing a user of the computer program product to provide user credentials and having the user credentials be verified to allow the user access to use one or more features of the computer program product. The product also includes a GPS/location map module for allowing the user to obtain a map for display on a display screen of a handheld device of the user. Further, this product includes a member location module for receiving information on one or more member locations and identifying the one or more member locations on the map. The product also includes a user location module for identifying and displaying a location of the user on the map, for updating the location of the user on the map when the user moves; and identifying and displaying other user information that are in a member location on the display screen when the user physically enters the member location. Furthermore, this product also includes a user information module for allowing the user to provide user information to be displayed to other users present in the same member location as the user. This product also includes a messaging module for allowing the user to communicate with other users that are in the same member location to determine whether the user and the other user want to meet for a face-to face communication.

Another exemplary embodiment includes a computer-implemented method for determining an invoice amount for a member location that allows a user to use a handheld device for facilitating the user of an application to interact face-to-face with another user of the application at the member location. This method includes the step of receiving, using a computer, a plurality of member location information for a member location. The method also includes the step of receiving, using a computer, a time data, for each visit that each user visited the member location during the billing cycle, from a handheld device of each user, the time data providing information for determining a total time the user was present at the member location during each visit to the member location during the billing cycle. Further, this method includes the step of determining a no charge time period for each user visit to the member location during the billing cycle. Moreover, this method includes the step of determining, using a computer, a remaining time period, for each visit that each user visited the member location during the billing cycle, by subtracting the no charge time period from each of the total time the user was present at the member location during each visit to the member location during the billing cycle, the remaining time period being zero if calculated to be negative. Furthermore, this method includes the step of determining, using a computer, a user billed time period, for each user, by summing each of the determined remaining time periods for that user. Also, this method includes the step of determining, using a computer, a user charge, for each user, by multiplying each of the user billed time periods by a value rate. Additionally, this method includes the step of determining, using a computer, an amount of invoice for the member location by summing each of the determined user charges.

### BRIEF DESCRIPTION OF THE DRAWINGS

Reference will now be made to the accompanying drawings, which are not necessarily drawn to scale, and wherein:

FIG. 1 is a schematic diagram of an exemplary application system in accordance with an exemplary embodiment;

FIG. 2 is a block diagram of one or more modules within the application in accordance with an exemplary embodiment;

FIGS. 3A and 3B are a flowchart presenting a method for interacting, potentially face-to-face, with another user of the application that is physically present at a same member location as the user, where the user identifies these other users once the user enters the same member location as the other user in accordance with an exemplary embodiment;

FIG. 4 is a frontal view of an exemplary login interface in accordance with an exemplary embodiment;

FIG. 5 is a frontal view of an exemplary GPS informational map in accordance with an exemplary embodiment;

FIG. 6 is a frontal view of an exemplary other user listing interface in accordance with an exemplary embodiment;

FIG. 7 is a frontal view of an exemplary user status interface in accordance with an exemplary embodiment;

FIG. 8 is a frontal view of an exemplary instant messaging interface in accordance with an exemplary embodiment;

FIG. 9 is a frontal view of an exemplary member location registration interface in accordance with an exemplary embodiment; and

FIG. 10 is a flow chart presenting a method for calculating the amount to be invoiced to a member location and having payment made in accordance with an exemplary embodiment.

The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of the exemplary embodiments. Further, certain elements and features shown in the drawings may be positioned elsewhere or may be removed or modified without limiting the scope of the exemplary embodiment of the invention. Additionally, certain dimensions or positionings may be exaggerated to help visually convey such principles. In the drawings, reference numerals designate like or corresponding, but not necessarily identical, elements.

### DETAILED DESCRIPTION OF THE EXEMPLARY EMBODIMENTS

Exemplary embodiments will now be described in detail with reference to the included figures. The exemplary embodiments are described in reference to how they might be implemented. In the interest of clarity, not all features of an actual implementation are described in this specification. Those of ordinary skill in the art will appreciate that in the development of an actual embodiment, several implementation-specific decisions must be made to achieve the inventors' specific goals, such as compliance with system-related and business-related constraints which can vary from one implementation to another. Moreover, it will be appreciated that such a development effort might be complex and time-consuming, but would nevertheless be a routine undertaking for those of ordinary skill in the art having benefit of this disclosure. Further aspects and advantages of the various figures of the invention will become apparent from consideration of the following description and review of the figures.

In a distributed computing environment, program modules and the data used within the program modules may be physically located in different local and remote memory storage devices or databases. Execution of the program modules may occur locally in a stand-alone manner or remotely in a client/server manner. Examples of such distributed computing environments include, but are not limited to, local area networks, enterprise wide computer networks, and the global Internet.

The detailed description that follows is represented largely in terms of processes and symbolic representations of operations by conventional computing components, including processing units, memory storage devices, databases, display devices, and input devices. These processes and operations may utilize conventional computer components in a stand-alone, distributed computing environment, or combination of both.

The processes and operations performed by the computer or application include the manipulation of signals by a processing unit or remote computer and the maintenance of these signals within data structures resident in one or more of the local or remote memory storage devices. Such data structures impose a physical organization upon the collection of data stored within a memory storage device and represent specific, electrical or magnetic elements. The symbolic representations are the means used by those skilled in the art of computer programming and computer construction to most effectively convey teachings and discoveries to others skilled in the art.

Exemplary embodiments of the present invention include an application program that embodies the functions described herein and illustrated in the flowcharts. However, it should be apparent that there could be many different ways of implementing the invention in application programming, and the invention should not be construed as limited to any one set of the computer program instructions. Furthermore, a skilled programmer would be able to write such a computer program to implement a disclosed embodiment of the present invention without difficulty based, for example, on the tables, representations, and flowcharts and associated description in the application text. Therefore, disclosure or a particular set of program code instructions is not considered necessary for an adequate understanding of how to make and use the exemplary embodiments of the present invention.

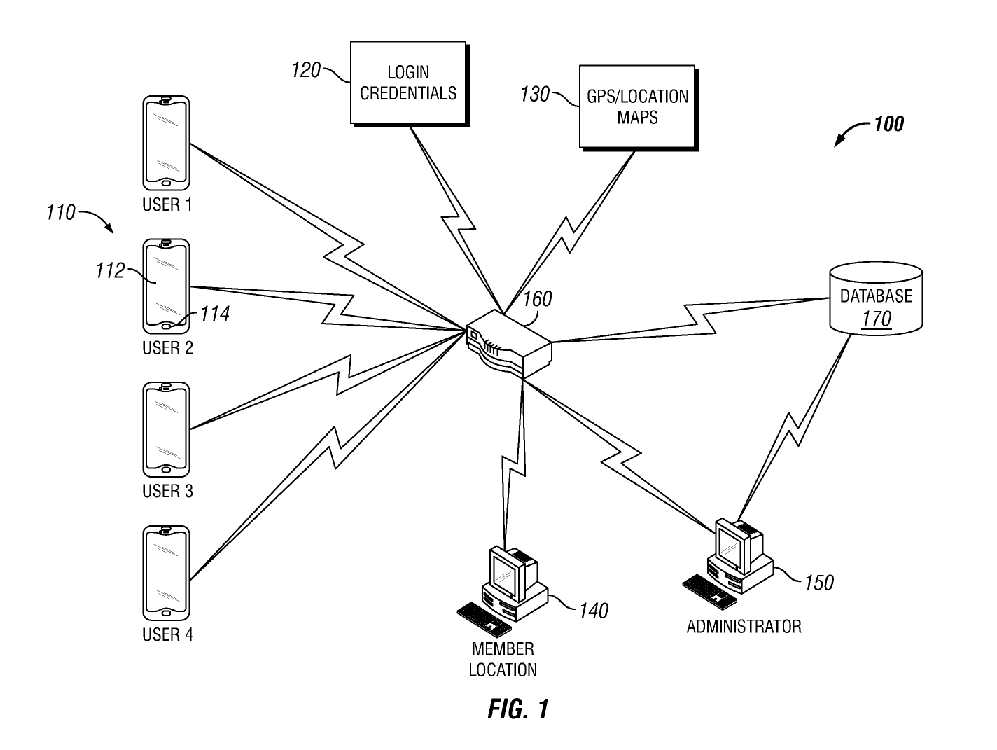

FIG. 1 is a schematic diagram of an exemplary application system 100 in accordance with an exemplary embodiment. Referring now to FIG. 1, the application system 100 includes one or more handheld devices 110, a login credentials site 120, a GPS/location maps site 130, a member location terminal 140, an administrator terminal 150, a data communicator 160, and a database 170, along with any data received, transmitted, and/or stored by one of the aforementioned components of the application system 100. Although certain components have been enumerated as being part of the application system 100, greater or fewer components may be used so long as the scope and spirit of the exemplary embodiments remain substantially the same. For example, some components may be combined with another component such that there are fewer components. For example, the functions of the login credentials site 120 and/or the GPS/location maps site 130 may be performed through the database 170, instead of being routed to a different site/application. Each of these components are briefly described below, however, some will be further described in more detail with respect to other Figures.

The handheld devices 110 may be a mobile phone, such as those manufactured by Apple, Samsung, Google, LG, AT&T, etcetera. However, one or more of the handheld devices 110 may be any other portable device that is capable of downloading and running an application, wirelessly being capable to transmit and/or receive data, and having a display screen. The handheld device 110, as shown, includes a display screen 112 and a user interface 114, which may be integrated into the display screen 112 or may be separate from the display screen 112 but part of the handheld device 110. For example, a keyboard (not shown) for typing may be part of the display screen 112 as in an iPhone manufactured by Apple or may be separate from the display screen 112 as in a Blackberry manufactured by Research In Motion (RIM). The application is downloaded to one or more handheld devices 110 by a user of the application. This application may be downloaded from iTunes, which is owned by Apple, for example, but may be downloaded onto one or more handheld devices 110 from other sources as well. Once the application is downloaded onto the handheld device 110, the application is installed automatically to run on that handheld device 110 and is setup once accessed for the first time. This setup of an application is known to those people having ordinary skill in the art and is therefore not described herein. In other exemplary embodiments, the application resides at a different location, and the handheld device 110 merely obtains data from the remotely located application and at least one other component in the application system 100. Further, the handheld device 110 is to send and receive data from at least the database 170. In certain exemplary embodiments, the handheld device 110 is able to send and/or receive data to the login credentials site 120 and/or the GPS/location maps site 130.

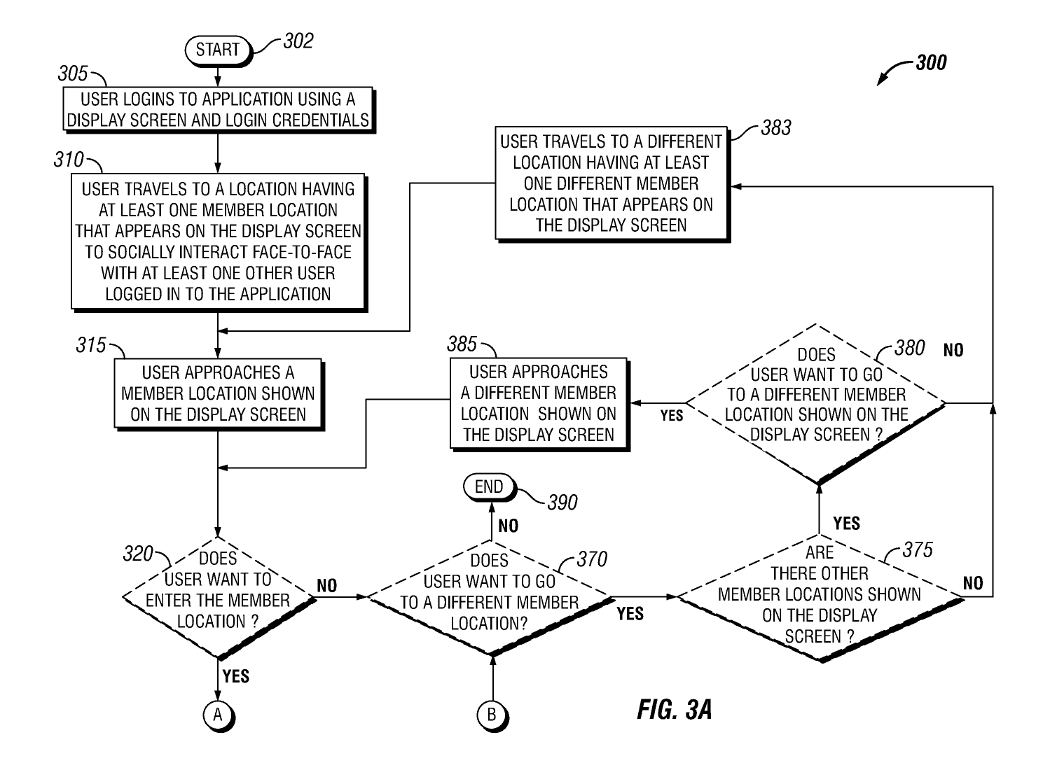

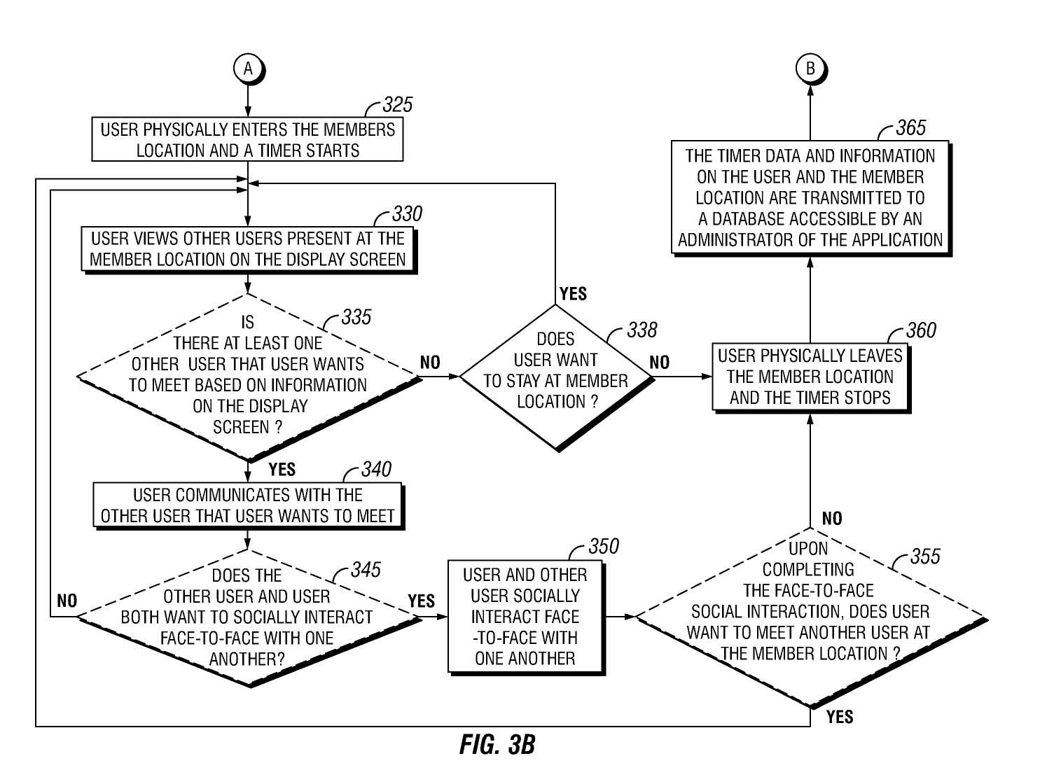

The login credentials site 120 is a site such as Facebook or Google that is able to verify the user credentials, such as a user name and password. The verification of user credentials by the login credentials site 120 allows the user access to use the application on the handheld device 110. Further the login credentials site 120 provides the profile picture that the user of the application would use in the application to display to other users of the application that are present at the same member location, which shall be described later. This profile picture may be provided from the login credentials site 120 or may be obtained directly from the user according to certain exemplary embodiments. Alternatively, in other exemplary embodiments, the functions of this login credentials site 120 may be provided by the database 170 in the event the database 170 is to store such information. The login credentials site 120 may receive information directly from the handheld device 110 or from the database 170. For example, the handheld device 110 sends information to the database 170 via the data communicator 160 and the database 170 sends information to the login credentials site 120, which then verifies the information back to the database 170 and then is sent to the handheld device 110. Alternatively, the information bypasses the database 170, and is communicated directly between the handheld device 110 and the login credential site 120 via the data communicator 160. Again, once the user login is verified, the user may use the functions of the application since the user has been authenticated. Further description on the login credentials site 120 is provided below with respect to descriptions related to FIGS. 3 and 4.

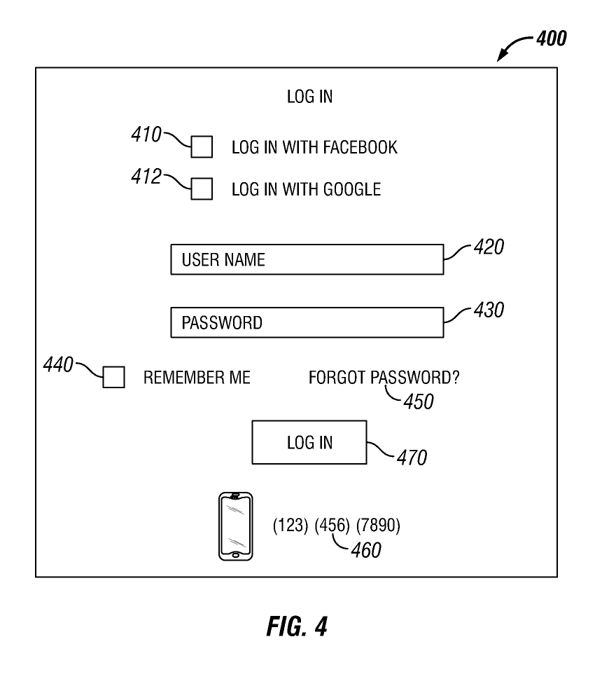

The GPS/location maps site 130 is a site such as Google maps, some other Google mapping application, or some other mapping application that provides mapping information capable of determining accurately where the user is located and whether the user has entered a member location. This mapping information is provided to the user and is displayed on the handheld device's 110 display screen 112. Further, this information is provided to the database 170, either from the GPS/location maps site 130 or from the handheld device 110 of the user, so that the database 170 and/or the administrator 150 can determine whether the user has entered the member location. According to certain exemplary embodiments, no other hardware is required within the member location to determine whether a user has entered its premises. Alternatively, some hardware may be installed at the member location to assist in determining exactly as to whether the user has entered its premises. This hardware, if required, is in the purview of those people having ordinary skill in the art and is therefore not described in detail herein. The GPS/location maps site 130 provides mapping information, positioning of the user on the map, and locations of all nearby businesses or socializing locations, including member locations. The GPS/location maps site 130 does not provide information as to which locations are member locations. Instead, the database 170 supplies information as to which locations are member locations so that the member locations are specifically identified on the display screen 112 of the handheld device 110. Hence, the display screen 112 shows which locations on the map are member locations so that the user may choose which locations to enter and which locations allow operation of certain features of the application. Alternatively, in other exemplary embodiments, the functions of this GPS/location maps site 130 may be provided by the database 170 in the event the database 170 is to store such mapping information. The GPS/location maps site 130 may receive information directly from the handheld device 110 or from the database 170. For example, the handheld device 110 sends information to the database 170 via the data communicator 160 and the database 170 sends information to the GPS/location maps site 130, which then provides mapping information back to the database 170 and then is sent to the handheld device 110. The database 170 may provide supplemental information so as to indicate which locations are member locations along with the mapping information. Alternatively, the information bypasses the database 170, and is communicated directly between the handheld device 110 and the GPS/location maps site 130 via the data communicator 160. The database 170 would independently provide information as to which locations are member locations and the application on the handheld device 110 would cause the display screen 112 to show the locations that are member locations with a special identifier. Further description on the GPS/location maps site 130 is provided below with respect to descriptions related to FIGS. 3 and 5.

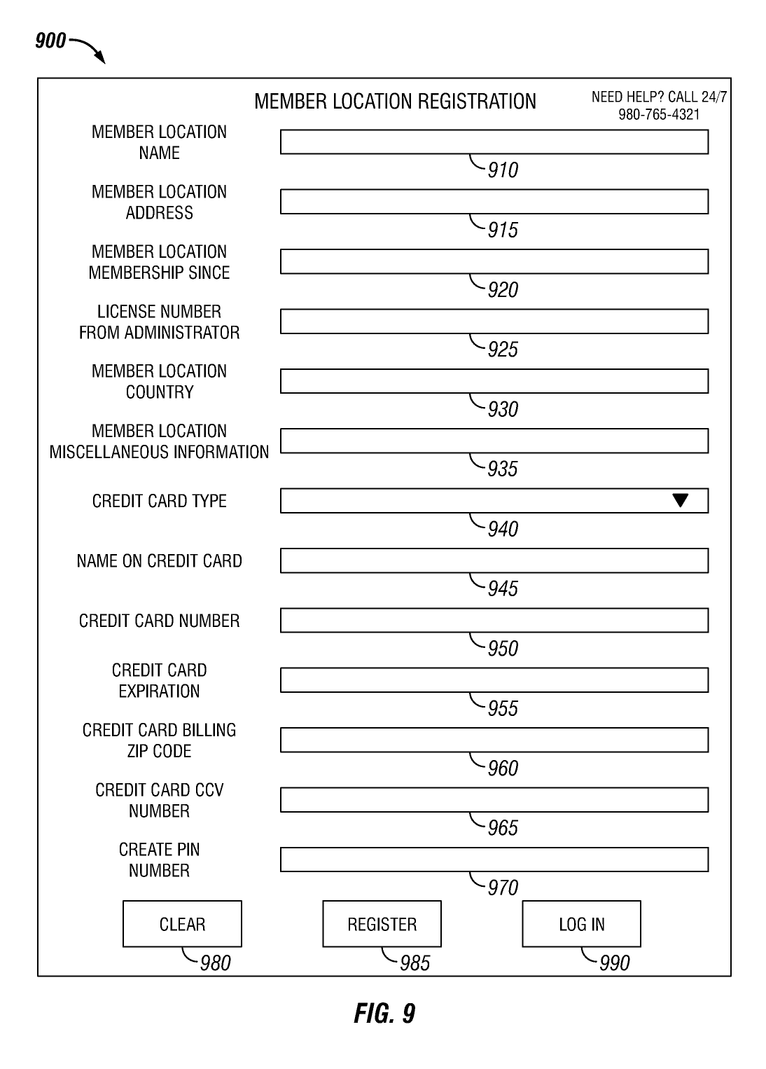

The member location terminal 140 is a general purpose computer in one exemplary embodiment, but may be a handheld device, including a tablet in other exemplary embodiments. The member location terminal 140 is a device capable of accessing the Internet and transmitting and/or receiving information to the database 170. The member location terminal 140 also includes a user interface so that information can be entered into application system 100 at the member location terminal 140. The member location terminal 140 allows a location to register with the application and/or administrator such that the location may become a member location. Once a location becomes a member location, functions of the application become operable for the user of the application once the user enters the member location. Further description on the member location terminal 140 is provided below with respect to descriptions related to FIG. 9.

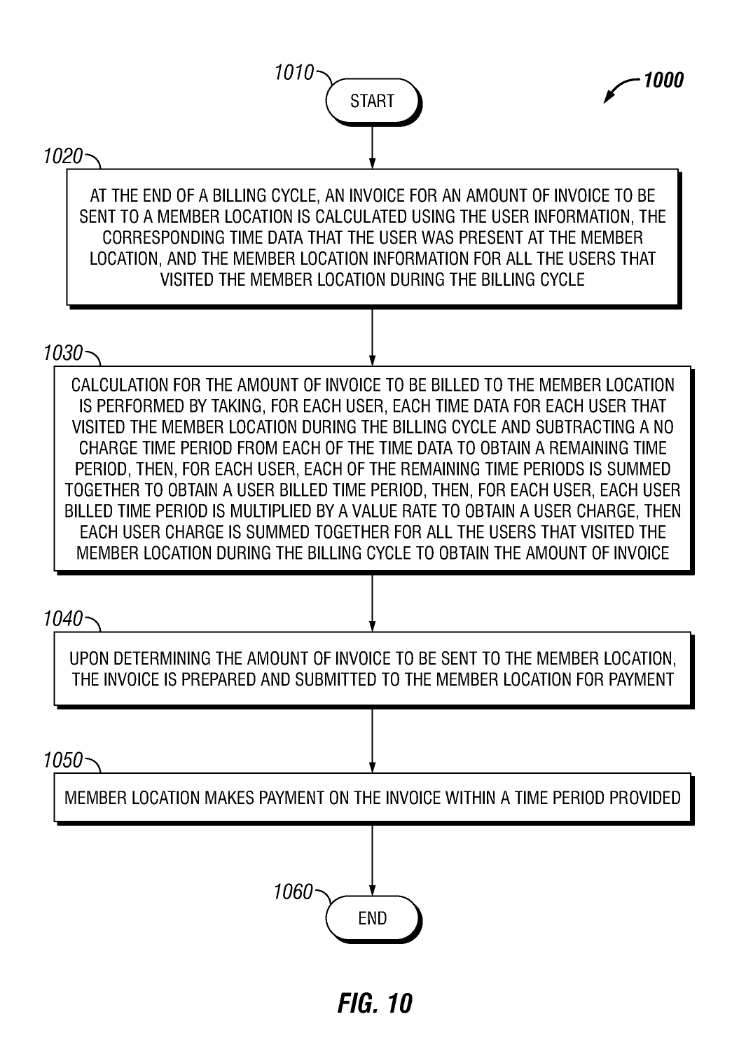

The administrator terminal 150 is a general purpose computer in one exemplary embodiment, but may be a handheld device, including a tablet in other exemplary embodiments. The administrator terminal 150 is a device capable of transmitting and/or receiving information to the database 170, either via hardwire or via wirelessly. The administrator terminal 150 also includes a user interface so that information can be entered into application system 100 at the administrator terminal 150. The administrator terminal 150 allows an administrator of the application to obtain information regarding the user, the member location, time data that user was present within the member location, and all other information required for invoicing the member location and obtaining backup data for invoicing regarding each member usage within the member location. The administrator has the capabilities to unregister any user and/or any member location for any reason, including non-payment by the member location or usage abuse by the user. Further description on the administrator terminal 150 is provided below with respect to descriptions related to FIG. 10.

The database 170 is either a separate database from the administrator terminal 150 or is integrated therewith. The database 170 collects and stores information regarding each user, each member location, and time data for each user when within a member location. Additionally, in certain exemplary embodiments, the database 170 may store user login credentials so that the login credentials site 120 is optional. Further, the database 170 may store GPS/location maps, which may be updated periodically to include new streets and locations, thereby causing the GPS/location maps site 130 to be optional. In certain exemplary embodiments, the database 170 stores instant messaging data for each user. In practice, this instant messaging data is either not stored in the database 170 or is stored for a nominal amount of time, such as thirty (30) days. The database 170 is a device, such as a database, dongle, compact disc drive, DVD drive or similar means for recording and storing the data that is communicated to it from any component of the application system 100. Further, the database, may send data to any component of the application system 100. The administrator of the application can control the database 170 with respect to archiving data, using data, retaining data, or deleting data.

The data communicator 160 is a modem that wirelessly connects to the Internet so as to access any component of the application system 100. Alternatively, the data communicator 160 can be a different component that is wired or wirelessly coupled to one or more of the different components of the application system 100 and communicates to and from the handheld devices 110, the login credentials site 120, the GPS location maps site 130, the member location terminal 140, the administrator terminal 150, and the database 170 if separate from the administrator terminal 150, by way of electrical cable, WiFi, satellite transmission, cellular transmission or any other means of data transmission known to those of ordinary skill in the art.

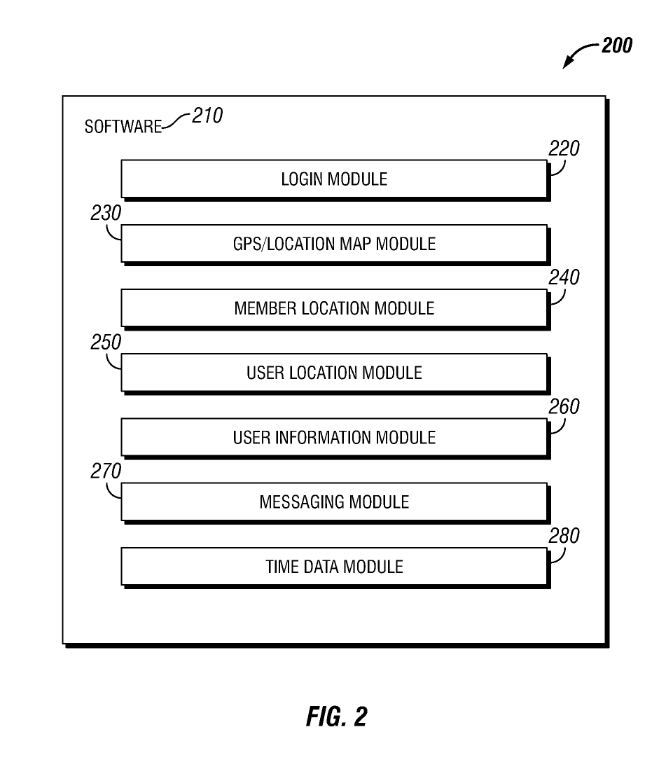

FIG. 2 is a block diagram 200 of one or more modules within the application 210 in accordance with an exemplary embodiment. The application 210 includes at least one module for allowing operation of the application 210. The application includes a login module 220, a GPS/location map module 230, a member location module 240, a user location module 250, a user information module 260, a messaging module 270, and a time data module 280. Accordingly, certain exemplary embodiments may have greater or fewer modules than those that are mentioned herein. Some modules may perform the operations of more than one modules while several other modules may perform the operations of a single module. Hence, these modules are not meant to be limiting in its scope and other embodiments that perform similar operations are included within the scope and spirit of the present embodiments described herein.

The login module 220 allows for a user of the application to provide user credentials so as to have those credentials verified and then allow for the user to use the features of the application 210. These credentials are a user name and/or a password which are then verified by an outside third party site, such as Facebook or Google. Alternatively, in certain exemplary embodiments, the credentials may be verified by information stored in the database 170 (FIG. 1). Yet in other exemplary embodiments, these credentials may take another form for verifying the user's identity. The application 210 receives information using the login module 220 from this third party site according to some exemplary embodiments, and the database 170 (FIG. 1) according to other exemplary embodiments, so as to verify the user information and then allow the user to use the application 210. The user credential information is further described with respect to the description provided with FIG. 4.

The GPS/location map module 230 allows for a user to obtain a map for display on the user's handheld device's 110 (FIG. 1) display screen 112 (FIG. 1) and for displaying the precise location of the user on the map. This map also provides information for all locations within the vicinity of the user, along with other landmarks according to some exemplary embodiments. This vicinity around the user can be one (1) mile, ten (10) miles, or some other radius distance from the user. This vicinity may be changeable by the user according to some exemplary embodiments, by changing settings in the application or by merely expanding or minimizing the screen by use of the user's fingers on the display screen 112 (FIG. 1). This GPS/map location is provided by an outside third party site, such as Google. Alternatively, in certain exemplary embodiments, these maps may be provided to the application 210 by information and applications stored in the database 170 (FIG. 1), which such maps can be updated periodically and stored within the database 170 (FIG. 1). The application 210 receives information using the GPS/location map module 230 from this third party site according to some exemplary embodiments, and the database 170 (FIG. 1) according to other exemplary embodiments, so as to provide a map display on the user's handheld device's 110 (FIG. 1) display screen 112 (FIG. 1) and to provide the precise location of the user. As mentioned below, the member location module 240 provides information to the application 210 to identify which locations are member locations and identify such on the map accordingly. Further, as mentioned below, the user location module 250 provides information to the application 210 and to the database as to the exact location of the user, specifically, whether the user has entered or left a member location. The GPS/location map information is further described with respect to the description provided with FIG. 5.

The member location module 240 provides information to the application 210 to identify which locations are member locations and identify such accordingly. In order for the member location module 240 to obtain this information, a member location must initially register itself with the application 210 so that its location is identified and stored in the database 170 (FIG. 1). The member location registration information is further described with respect to the description provided with FIG. 9 below. The application 210 receives information using the member location module 240 from the database 170 (FIG. 1) so as to identify which locations are member locations and display such information on the user's display screen 112 (FIG. 1) so that a user can go to these member locations to view other users present at the same member location and where the user may engage in a face-to-face social interaction with that other user. The display of member locations is shown with respect to FIG. 5, which is described in further detail below.

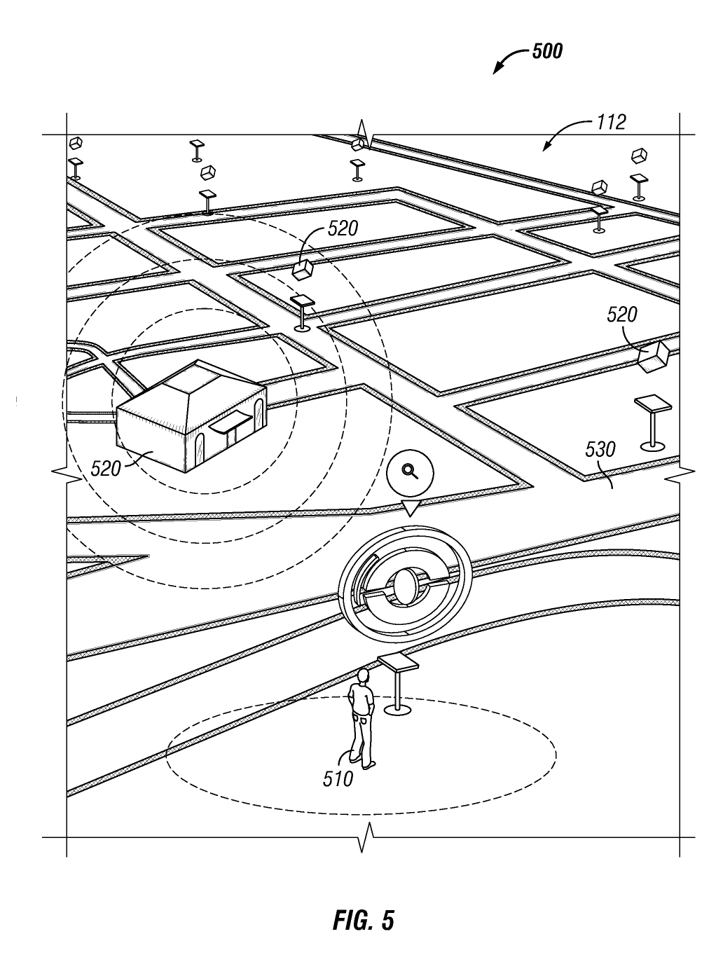

The user location module 250 obtains information from the GPS/location map module 230 regarding the precise location of the user, whether or not the user has entered or left a member location, and send this information to the database 170 (FIG. 1). Once a user enters a member location, the user location module 250 receives information from the database 170 (FIG. 1) regarding which users have entered and are still at the same member location as the user. This information is displayed on the user's display screen 112 (FIG. 1) so that the user can identify which other users are present at that member location and determine which, if any, other user to meet face-to-face for social interaction purposes. The display of other users locations at the same member location is shown with respect to FIG. 6, which is described in further detail below.

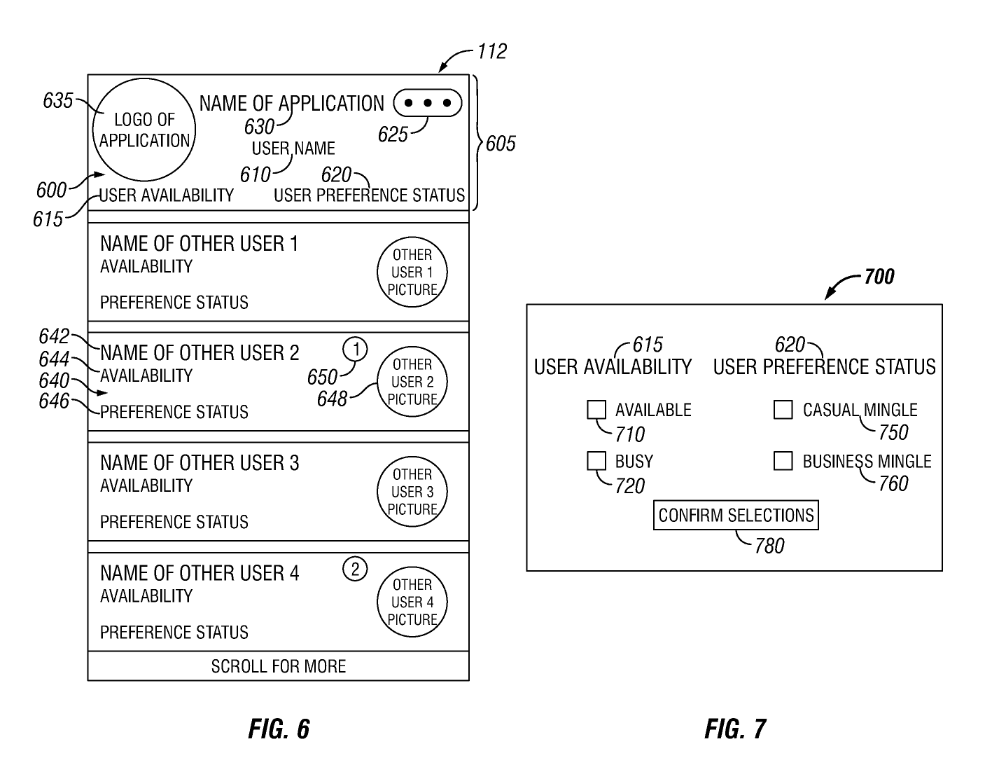

The user information module 260 allows the user to provide user information, such as the user's purpose for being at the member location and/or whether the user is available or not for social interaction with another user. According to some other exemplary embodiments, additional user information may be obtained by the user information module 260 and display to other users that are in the same member location as the user. The user information module 260 transmits information to the database 170 (FIG. 1), which then transmits the information to other users that are present at the same member location as the user. The user may change this information at any time using the user information module 260, which then provides this information to other users in the same member location immediately. The user information that is displayed to other users at the same member location as the user is shown with respect to FIG. 7, which is described in further detail below.

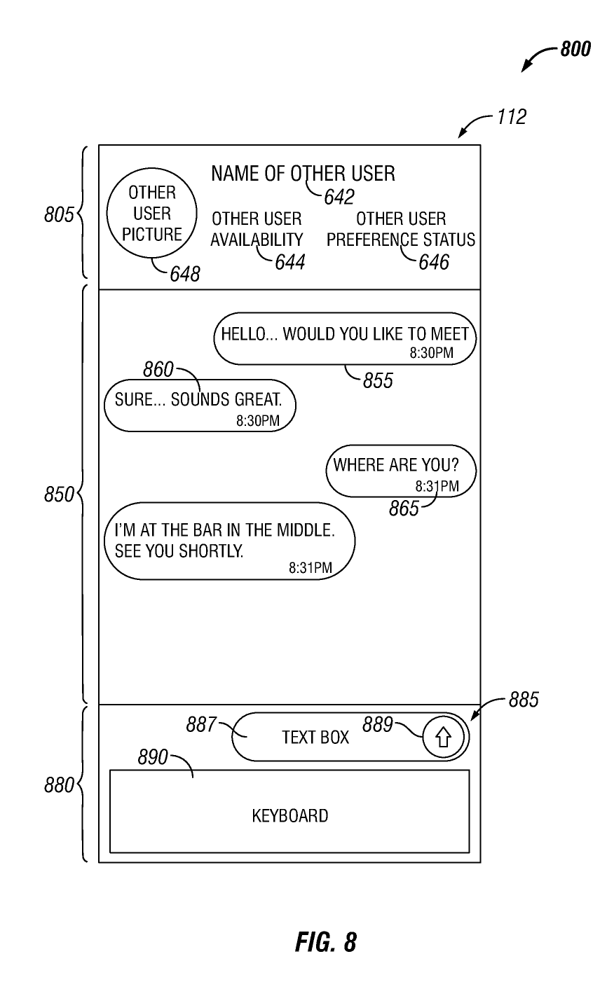

The messaging module 270 allows the user to communicate with other users that are in the same member location via instant messaging. The user will have a list of other users displayed on the user's display screen 112 (FIG. 1) along with the other user status via the user information module 260. The user selects the other user the user wants to instant message by tapping on the other user. A texting screen appears with that other user, as shown and described in further detail with respect to FIG. 8. According to some exemplary embodiments, the user may select any other user for instant messaging that is displayed on the user's display screen 112 (FIG. 1). However, in other exemplary embodiments, the user is not able to select those other users that have a status shown as being busy as those other users do not want to be disturbed.

The time data module 280 provides timing data to be recorded into the database 170 (FIG. 1) regarding the amount of time the user was present within each member location. The timing data module 280 measures time starting whenever a user enters a member location and stops measuring time when the user leaves the member location. For each member location, the date, the timing data of the user with start time and stop time, the user identification, and the member location is provided to the database 170 (FIG. 1) for being stored therein. This information allows the administrator of the application 210 to invoice each member location at a certain time period, which may be monthly. The invoice to the member location is based on the amount of time the user was present at the member location. FIG. 10 provides a flowchart which further describes the invoicing process and further details are provided below in conjunction with the description for FIG. 10.

FIGS. 3A and 3B are a flowchart presenting a method 300 for interacting, potentially face-to-face, with another user of the application that is physically present at a same member location as the user, where the user identifies these other users once the user enters the same member location as the other user in accordance with an exemplary embodiment. While describing FIGS. 3A and 3B, reference will be made to FIGS. 4, 5, 6, 7, and 8, which will be introduced at the appropriate time. Referring to FIGS. 3A and 3B, the exemplary method 300 begins at the START step 302 and proceeds to step 305, where a user logins to the application 210 (FIG. 2) using the display screen 112 (FIG. 1) and login credentials. Once the application 210 (FIG. 2) starts, a screen appears on the display screen 112 (FIG. 1) requesting the user to login to the application 210 (FIG. 2). FIG. 4 is a frontal view of an exemplary login interface 400 in accordance with an exemplary embodiment. FIG. 4 provides one example of a login interface 400, however, other types of login interfaces may be used to identify and verify the user, which may request similar or different types of information. Referring to FIGS. 3A, 3B, and 4, the login interface 400 allows the user to enter credentials, such as a user name 420 and a password 430, for verification with either Facebook or Google. The user also marks the Facebook box 410 if providing credentials to be verified by Facebook or the Google box 412 if providing credentials to be verified by Google. In other exemplary embodiments, the credentials may be verified internally within the application 210 (FIG. 2) using information stored within the database 170 (FIG. 1). Alternatively, in other exemplary embodiments, other third party sites may be used to verify credentials. Further, the user may choose to mark the remember box 440 so that the user does not have to re-enter the credentials each time the user starts the application 210 (FIG. 2). For assistance, a password reminder link 450 is provided to assist users in providing them with information to either remind them of their password 430 or allowing them to reset their password 430. This type of password reminder link 450 is within the knowledge of people having ordinary skill in the art and therefore is not described in further detail. Additionally, the phone number 460 of the user is displayed on the login interface 400; however, this feature is optional. Once the user enters the user credentials 420, 430, and the method of verifying 410, 412 the user credentials 420, 430, the user taps the login button 470 to have the user credentials 420, 430 verified.

FIG. 5 is a frontal view of an exemplary GPS informational map 500 in accordance with an exemplary embodiment. Referring to FIGS. 3A, 3B, and 5, upon logging in to the application 210 (FIG. 2), the display screen 112 displays the GPS informational map 500 showing where the user 510 is located and where member locations 520 are located with respect to the user 510. According to certain exemplary embodiments, the user 510, member locations 520, and streets 530 are shown. According to other exemplary embodiments, non-member locations (not shown) and/or other landmarks (not shown) are shown in the GPS informational map 500. The GPS informational map 500 may be made to show a greater radius surrounding and less detail or may be made to show a smaller radius surrounding and more detail according to certain exemplary embodiments. These changes may be made by the user by using fingers on the display screen 112, like a pinching action or an expanding action, or by changing a settings depending upon the exemplary embodiment.

Upon logging into the application 210 (FIG. 2) at step 305 and the GPS informational map 500 being displayed on the user's display screen 112, the method 300 proceeds to step 310. At step 310, the user 510 travels to a location having at least one member location 520 that appears on the display screen 112 to socially interact face-to-face with at least one other user logged into the application 210 (FIG. 2). As shown in FIG. 5, several member locations 520 appear on the user's display screen 112.

Once a member location 520 appears on the display screen 112 at step 310, the method 300 proceeds to step 315. At step 315, the user 510 approaches a member location 520 shown on the display screen 112. As shown in FIG. 5, as the user 510 approaches a member location 520, the member location 520 appears in a different form, such as a business site. The other member locations 520 that are still at a distant appear as a cube 520 so as to not take up as much space on the display screen 112. However, in alternative exemplary embodiments, the member locations 520 may appear in different forms and also may not change forms as it becomes closer to the user 510.

Upon the user 510 approaching the member location 520 at step 315, the method 300 proceeds to step 320. At step 320, the user 510 decides whether to enter the member location 520.

If the user 510 decides to enter the member location 520, the method 300 proceeds along the “YES” branch from step 320 to step 325. At step 325, the user 510 physically enters the member location 520 and a timer starts. The timer is located within the user's handheld device 110 (FIG. 1); however, in alternative exemplary embodiments, the timer may be located at the database 170 (FIG. 1). Upon entering the member location 520, the user's display screen 112 is changed from the display screen 112 shown in FIG. 5 to the display screen 112 (FIG. 6) as shown in FIG. 6, which is described in further detail below.

Upon the user 510 physically entering the member location 520 at step 325, the method 300 proceeds to step 330. At step 330, the user 510 views other users present at the member location 520 on the user's display screen 112 (FIG. 6). FIG. 6 is a frontal view of an exemplary other user listing interface 600 in accordance with an exemplary embodiment. Referring to FIGS. 3A, 3B, 4, 5, and 6, the other user listing interface 600 includes a listing of other users 640 that are present at the same member location 520 as the user 510. Each listing of other users 640 includes a user name of the other user 642, an availability of the other user 644, a preference status of the other user 646, a picture of the other user 648, and a number of instant messages sent by the other user to the user 650. Although each listing of other users 640 includes the aforementioned information, more, less, or different information may be included in each of the listing of other users 640 depending upon the exemplary embodiment. In the event the display screen 112 does not fit the entire listing of other users 640, the listing of other users 640 may be scrolled upwards to view the other users within the listing of other users 640 that are present at the same member location 520 as the user 510. When scrolling upwards, the top section 605 remains stationary according to some exemplary embodiments. Further, according to some exemplary embodiments, the listing of other users 640 may be refreshed by the user 510 by going to the bottom of the listing of other users 640 and attempting to continue to scroll upwards. Alternatively, in other exemplary embodiments, there may be a button or icon that may be pressed/touched to refresh the listing of other users 640.

The user name of the other user 642 is provided from the database 170 (FIG. 1) since the other user has logged into the application 210 (FIG. 2) and the application 210 (FIG. 2) tracks the location of the other user and transmits the information to the database 170 (FIG. 1). The database 170 (FIG. 1) has location information stored for each user whenever any user enters or leaves a member location 520. The availability of the other user 644 is either available or busy according to some exemplary embodiments, but may include other options in other exemplary embodiments. The other user chooses which option should be displayed to other users and the information is transmitted to the database 170 (FIG. 1), which then transmits this information to other users at the same member location 520. The preference status of the other user 646 is either casual mingle or business mingle, but may include other options according to some exemplary embodiments. The other user chooses which option should be displayed to other users and the information is transmitted to the database 170 (FIG. 1), which then transmits this information to other users at the same member location 520. The picture of the other user 648 is a profile picture of the other user and is obtained from the third party verification site, such as Facebook or Google depending upon the exemplary embodiment. According to other exemplary embodiments, the picture of the other user 648 may be stored in the database 170 (FIG. 1) and is sent to the user 510 from the database 170 (FIG. 1). The number of instant messages 650 sent by the other user to the user is obtained either directly from the other user's handheld device 110 (FIG. 1) or from the database 170 (FIG. 1) depending upon the exemplary embodiment. The database 170 (FIG. 1) may provide phone number information of all users that are at the same member location 520 as the user 510, but this information is not visible to any of the users. Alternatively, all communication is sent to the database 170 (FIG. 1) and the database 170 (FIG. 1) then sends it to the other user. The number of instant messages 650 sent by the other user to the user represents all instant messages that the other user sent to the user 510 and which the user 510 has not yet read. Reading the instant message involves the user 510 (FIG. 5) pressing on that other user on the display screen 112, thereby being transferred to an instant messaging screen to view the messages, which is depicted in FIG. 8 and is described in further detail below.

The top section 605 includes a user name 610, a user availability 615, a user preference status 620, and a menu button 625. In certain exemplary embodiments, the top section 605 also includes a name of the application 630 and an application logo 635, however, this is optional. Further, although the top section 605 shows certain information displayed therein, the top section 605 may include different information or there may not be a top section 605 according to certain exemplary embodiments. The user name 610 is the name of the user of the handheld device 110 (FIG. 1). The user availability 615 is set to either available or busy by the user 510, although other options may be available to be chosen by the user 510 in other exemplary embodiments. The user preference status 620 is set to either casual mingle or business mingle by the user 510, although other options may be available to be chosen by the user 510 in other exemplary embodiments. The menu button 625 allows the user access to change the user availability 615 and the user preference status 620, which is described in further detail with respect to FIG. 7.

FIG. 7 is a frontal view of an exemplary user status interface 700 in accordance with an exemplary embodiment. Referring to FIG. 7, the user status interface 700 includes selections for user availability 615 and selections for user preference status 620 that are applicable to the user 510 (FIG. 5). The selections for user availability 615 include an available box 710 and a busy box 720. Selecting the available box 710 means that the user 510 (FIG. 5) is available for instant messaging and/or a face-to-face meeting with another user, while selecting the busy box 720 means that the user 510 (FIG. 5) is unavailable for instant messaging and/or a face-to-face meeting with another user. Although this exemplary embodiments includes two options for the user availability 615, other exemplary embodiments may have greater, fewer, or different options for the user availability 615. The selections for user preference status 620 include a casual mingle box 750 and a business mingle box 760. Selecting the casual mingle box 750 means that the user 510 (FIG. 5) is available for communicating with another user for purposes of being casual, while selecting the business mingle box 760 means that the user 510 (FIG. 5) is available for communicating with another user for purposes of business and/or business opportunities. Although this exemplary embodiments includes two options for the user preference status 620, other exemplary embodiments may have greater, fewer, or different options for the user preference status 620. The user 510 (FIG. 5) is to select one option for each of the user availability 615 and the user preference status 620. Upon selecting the appropriate options for user availability 615 and user preference status 620, the user 510 (FIG. 5) presses/touches the confirm selections button 780 to save these choices. Referring back to FIGS. 6 and 7, the user 510 (FIG. 5) may change the selected choices at any time the user 510 (FIG. 5) is in any member location 520 (FIG. 5) by pressing the menu button 625 and accessing the user status interface 700.

Once the user 510 (FIG. 5) selects the appropriate user availability 615 and user preference status 620, the other users are displayed on the other user listing interface 600 according first to matching user availability 615 on top and then matching user preference status 620 below according to certain exemplary embodiments. In other exemplary embodiments, the other users may be displayed by other criteria, such as alphabetically, length of time other user has been in the member location 520 (FIG. 5), and sex of other user. According to some exemplary embodiments, the application 210 (FIG. 2) allows the user 510 (FIG. 5) to select and/or change the criteria that the other users are displayed on the other user listing interface 600.

Upon the user 510 (FIG. 5) viewing the other users present at the member location 520 (FIG. 5) at step 330, the method 300 proceeds to step 335. At step 335, the user 510 (FIG. 5) decides whether there is at least one other user that the user 510 (FIG. 5) wants to meet based on information displayed on the display screen 112. This information includes at least one of the user name of the other user 642, the availability of the other user 644, the preference status of the other user 646, the picture of the other user 648, and the number of instant messages sent by the other user to the user 650.

In the event the user 510 (FIG. 5) decides there are no other users that user 510 (FIG. 5) wants to meet based on information on the display screen 112 (FIG. 5), method 300 proceeds along the “NO” branch to step 338. At step 338, it is determined whether the user 510 (FIG. 5) wants to stay at the member location 520. In the event user 510 (FIG. 5) wants to stay at the member location 520 (FIG. 5) at step 338, method 300 proceeds along the “YES” branch back to step 330, which has been previously described. However, in the event user 510 (FIG. 5) does not want to stay at the member location 520 (FIG. 5) at step 338, method 300 proceeds along the “NO” branch to step 360, which will be described in further detail below.

However, at step 335, if the user 510 (FIG. 5) decides that the user 510 (FIG. 5) wants to meet one other user from the listing of other users 640, the method 300 proceeds along the “YES” branch from step 335 to step 340. At step 340, the user 510 (FIG. 5) communicates with the other user that the user 510 (FIG. 5) wants to meet. Referring to FIGS. 3A, 3B, 6, and 8, the user 510 (FIG. 5) taps on some portion of where the other user information is shown on the user's display screen 112, such as on the user name of the other user 642, the picture of the other user 648, or some other information of the other user that is displayed. Upon tapping on the other user information, the display screen 112 shows an instant messaging interface 800, as shown in FIG. 8. FIG. 8 is a frontal view of an exemplary instant messaging interface 800 in accordance with an exemplary embodiment. Although FIG. 8 shows one example of the instant messaging interface 800, other exemplary embodiments may have an instant messaging interface that is different.

The instant messaging interface 800 is an interface that allows the user 510 (FIG. 5) and the other user to send and receive instant messages from each other. The instant messaging interface 800 includes a top section 805, a middle section 850, and a bottom section 880. The top section 805 includes information about the other user that the user 510 (FIG. 5) is wanting to instant message with. The top section includes the name of the other user 642, the picture of the other user 648, the availability of the other user 644, and the preference status of the other user 646. This top section 805 includes the aforementioned information of the other user so that the user 510 (FIG. 5) may view this information while sending instant messages to that other user. Although the top section 805 includes the aforementioned information of the other user, the top section 805 includes different information in other exemplary embodiments, or the top section 805 may not be present at all.

The middle section 850 includes the user sent instant messages 855 and the user received instant messages 860. The user sent instant messages 855 are instant messages sent by the user 510 (FIG. 5), while the user received instant messages 860 are instant messages sent to the user 510 (FIG. 5) from the other user. According to some exemplary embodiments, the user sent instant messages 855 are positioned on the right side of the display screen 112, while the user received instant messages 860 are positioned on the left side of the display screen 112. According to other exemplary embodiments, the positioning of the user sent instant messages 855 and the user received instant messages 860 may be different than that mentioned above. Further, according to some exemplary embodiments, a time stamp 865 is provided to identify when an instant message was sent or received.

The bottom section 880 provides a user interface 885 that includes a text box 887 with an arrow 889 and a keyboard 890. The keyboard 890 allows the user 510 (FIG. 5) to type a message into the text box 887. Once the message has been completed, the user 510 (FIG. 5) taps the arrow 889 to send the instant message to the other user, which appears on the right side of the display screen 112.

Hence, at step 340 when the user 510 (FIG. 5) decides to communicate with another user, the user 510 (FIG. 5) types a message to the other user requesting a meet, such as the instant message shown at the top right of the display screen 112.

Once the user 510 (FIG. 5) communicates with the other user that the user 510 (FIG. 5) wants to meet at step 340, method 300 proceed to step 345. At step 345, a determination is made whether the other user and the user 510 (FIG. 5) both want to socially interact face-to-face with one another. This determination is made pursuant to an instant message response or a non-response from the other user.

In the event the user 510 (FIG. 5) and the other user decide that they do not want to meet and socially interact face-to-face with one another at step 345, method 300 proceeds along the “NO” branch back to step 330. However, if the user 510 (FIG. 5) and the other user decide that they both want to meet and socially interact face-to-face with one another at step 345, the method 300 proceeds along the “YES” branch from step 345 to step 350. At step 350, the user 510 (FIG. 5) and the other user meet and socially interact face-to-face with one another.

Upon concluding the user 510 (FIG. 5) and the other user face-to face social interaction at step 350, method 300 proceeds to step 355. At step 355, the user 510 (FIG. 5) determines whether the user 510 (FIG. 5) wants to meet another user at the member location 520 (FIG. 5).

In the event the user 510 (FIG. 5) decides that the user 510 (FIG. 5) wants to meet another user at the member location 520 (FIG. 5) at step 355, method 300 proceeds along the “YES” branch back to step 330. However, in the event the user 510 (FIG. 5) decides that the user 510 (FIG. 5) does not want to meet another user at the member location 520 (FIG. 5) at step 355, method 300 proceeds along the “NO” branch to step 360. At step 360, the user 510 (FIG. 5) physically leaves the member location 520 (FIG. 5) and the timer stops. As previously mentioned, the timer may be integrated with the handheld device 110 (FIG. 1) according to some exemplary embodiments, while alternatively, the timer is at the database 170 (FIG. 1). Once the user 510 (FIG. 5) leaves the member location 520 (FIG. 5), the display screen 112 appears as shown in FIG. 5 with the GPS informational map 500 (FIG. 5).

Referring to FIGS. 3A, 3B, and 5, upon the user 510 physically leaving the member location 520 at step 360, the method 300 proceeds to step 365. At step 365, the timer data and information on the user 510 and the member location 520 are transmitted to the database 170 (FIG. 1), if not already present at the database 170 (FIG. 1), accessible by an administrator of the application 210 (FIG. 2). As is described below with respect to FIG. 10, this information at the database 170 (FIG. 1) is used to invoice the member locations 520. Although step 365 occurs immediately after step 360, step 365 may occur at any time after step 360 in other exemplary embodiments.

Upon the user 510 physically leaving the member location at step 360 and possibly after the timer data and other information is transmitted to the database 170 (FIG. 1) at step 365, method 300 proceeds to step 370. At step 370, it is determined whether the user 510 wants to go to a different member location 520.

In the event user 510 decides not to go to a different member location 520 at step 370, method 300 proceeds along the “NO” branch to step 390. At step 390, method 300 ends. However, in the event user 510 decides that user 510 wants to go to a different member location 520 at step 370, method 300 proceeds along the “YES” branch to step 375. At step 375, it is determined whether there are other member locations 520 shown on the display screen 112.

In the event that it is determined that there are no other member locations 520 shown on the display screen 112 at step 375, method 300 proceeds along the “NO” branch to step 383. At step 383, the user 510 travels to a different location having at least one different member location 520 that appears on the display screen 112. Method 300 then proceeds back to step 315.

However, if it is determined that there are other member locations 520 shown on the display screen 112 at step 375, method 300 proceeds along the “YES” branch to step 380. At step 380, it is determined whether the user 510 wants to go to a different member location 520 shown on the display screen 112. In the event user 510 does not want to go to a different member location 520 shown on the display screen 112 at step 380, method 300 proceeds along the “NO” branch to step 383, which has been previously described. However, in the event that user 510 wants to go to a different member location 520 shown on the display screen 112 at step 380, method 300 proceeds along the “YES” branch to step 385. At step 385, the user 510 approaches a different member location 520 shown on the display screen 112. From step 385, method 300 proceeds to step 320, as previously described.

Although the steps described with respect to method 300 are as aforementioned, other exemplary embodiments may have certain steps performed in a different order, some step may be omitted, or some steps may be added or slightly modified, without departing from the scope and spirit of the exemplary embodiments.

FIG. 9 is a frontal view of an exemplary member location registration interface 900 in accordance with an exemplary embodiment. The member location registration interface 900 is not part of the software 210 (FIG. 2); however, the member location registration interface 900 is performed to provide member location 520 (FIG. 5) information to the database 170 (FIG. 1) for purposes of providing information onto the GPS informational map 500 and for invoicing purposes as described below with respect to FIG. 10. The member location registration interface 900 includes a member location name box 910, a member location address box 915, a member location member since box 920, a license number from administrator box 925, a member location country box 930, a member location miscellaneous information box 935, a credit card type box 940, a name on credit card box 945, a credit card number box 950, a credit card expiration box 955, a credit card billing zip code box 960, a credit card CCV number box 965, and a create a pin number box 970. Further, the member location registration interface 900 also includes a clear button 980, a register button 985, and a log in button 990.

The member location name box 910 allows a person filling out the member location registration interface 900 to enter a name for the member location 520 (FIG. 5), such as the business name. The member location address box 915 is the box where the full address of the member location 520 (FIG. 5) is entered, which includes the street address, city, state, and zip code. The member location member since box 920 is the box where the year the member location 520 (FIG. 5) became a member. Typically, according to some exemplary embodiments, this member location member since box 920 is automatically filled out at the time of registration. The license number from administrator box 925 is a box where a license number, or code, is provided from the administrator of the software 210 (FIG. 2), which allows the member location 520 (FIG. 5) to identify itself to the administrator. Typically, this license number from administrator box 925 is automatically filled out at the time of registration according to some exemplary embodiments. The member location country box 930 is the box where country location of the member location 520 (FIG. 5) is at. The member location miscellaneous information box 935 is the box where additional information may be provided, such as contact information for the member location 520 (FIG. 5), manager name of the member location 520 (FIG. 5), e-mail address of the manger of the member location 520 (FIG. 5), etcetera. The credit card type box 940 is a pull down box where several different credit cards may be chosen and that are accepted by the administrator. The name on credit card box 945 is the box where the name of the person that is listed on the credit card may be entered. The credit card number box 950 is the box where the credit card number may be entered. The credit card expiration box 955 is the box where the expiration date of the credit card may be entered. The credit card billing zip code box 960 is the box where the zip code of the billing address for the credit card may be entered. The credit card CCV number box 965 is the box where the CCV number of the credit card may be entered. The create a pin number box 970 is the box where a pin number may be entered. This pin number allows the person representing the member location 520 (FIG. 5) to log in to the system and change any of this information, except for the information in the member location member since box 920 and the license number form administrator box 925. This pin number may be a 4-digit code, a 6-digit code, or any other pin having numbers, alphabets, special characters, or a combination of any of the aforementioned characters. The clear button 980, if clicked upon, allows for all information on the member location registration interface 900 to be cleared except for the information in the member location member since box 920 and the license number form administrator box 925. The register button 985, if clicked upon, registers the member location 520 (FIG. 5) with the software 210 (FIG. 2) and does so only when all information has been provided in the member location registration interface 900. The log in button 990, if clicked upon, allows for a person representing the member location 520 (FIG. 5) to enter the information on the member location registration interface 900, for which the member location 520 (FIG. 5) has already been registered, and update any information that is needing to be updated. Upon clicking on the log in button 990, a different page, not shown, is pulled up and the person representing the member location 520 (FIG. 5) will need to provide access credentials, such as the pin number which was provided in the create pin number box 970 and the license number which was provided in the license number from administrator box 925 during registration. Although the member location registration interface 900 includes the information as aforementioned, greater, less, or different information may be solicited from the member location 520 (FIG. 5) during registration in accordance with some exemplary embodiments.

FIG. 10 is a flow chart presenting a method 1000 for calculating the amount to be invoiced to a member location 520 (FIG. 5) and having payment made in accordance with an exemplary embodiment. Method 1000 is performed using software residing in a computer or some other device having a processor. Referring to FIGS. 5 and 10, method 1000 starts at step 1010. After step 1010, method 1000 proceeds to step 1020.

At step 1020, at the end of a billing cycle, an invoice for an amount of invoice to be sent to a member location 520 is calculated using the user information, the corresponding time data that the user 510 was present at the member location 520, and the member location information for all the users 510 that visited the member location 520 during the billing cycle. A billing cycle may be a 30-day period according to some exemplary embodiments, while in other exemplary embodiments, the billing cycle may be one full month, which may be 28-days, 29-days, 30-days, or 31-days depending upon the month. Alternatively, the billing cycle may be any other time period, such as 2-weeks or quarterly. The user information may include a user name or a user identification number which is identifiable to the administrator of the program but not the member location 520. However, in some exemplary embodiments, at least some of the user information may be identifiable to the member location 520. The corresponding time data that the user 510 was present at the member location 520 is the differential time data of the stop time minus the start time for that user 510 each occurrence that the user 510 entered and exited that member location 520. Hence, the corresponding time data for the user 510 is the amount of time the user 510 was present at the member location 520 for each occurrence that the user 510 entered and exited the member location 520. The member location information is the information regarding the member location 520, and includes one or more of member location name, member location address, member location other information, such as contact name and/or telephone.

Method 1000 then proceeds to step 1030. At step 1030, calculation for the amount of invoice to be billed to the member location 520 is performed by taking, for each user, each time data for each user that visited the member location 520 during the billing cycle and subtracting a no charge time period from each of the time data to obtain a remaining time period. For each user, each of the remaining time periods is summed together to obtain a user billed time period. For each user, each user billed time period is then multiplied by a value rate to obtain a user charge. Then, each user charge is summed together for all the users that visited the member location during the billing cycle to obtain the amount of invoice. According to certain exemplary embodiments, the no charge time period may be twenty minutes. Alternatively, in other exemplary embodiments, this no charge time period may be greater or less than the twenty minutes, and may also include zero minutes according to some exemplary embodiments. For certain exemplary embodiments, this no charge time period is to accommodate for users that enter and leave within a short period and may not bring any revenue to the member location 520. After subtracting a no charge time period form each of the time data for each user, a remaining time period is obtained. For each user, this remaining time period is summed together, to obtain a user billed time period. This user billed time period is the time period that is billed to the member location 520 for each user 510. Each user billed time period is then multiplied by a value rate to obtain a user charge. The value rate may be $0.01 per minute or some other value according to other exemplary embodiments. According to some exemplary embodiments, this value rate may be a block billed amount, which is $0.20 per twenty minutes, which is equivalent to $0.01 per minute, however, for any non-full block period, there is no charge. For example, is a user 510 stayed at the member location for fifty-three minutes, the no charge time period may be twenty minutes, making the remaining time period to be thirty-three minutes. Assuming the user 510 visited the member location only once during the billing cycle, the remaining time period is the user billed time period. The member location, if billed at a value rate of $0.20 per twenty minutes, would be billed $0.20 and the remaining thirteen minutes would not be billed since that amount of time did not reach the next block time period of twenty minutes. The user charge is the total amount that is billed to the member location 520 for that particular user 510. Then, each user charge is summed together for all the users that visited the member location 520 during the billing cycle to obtain the amount of invoice to that member location 520.

Method 1000 then proceeds to step 1040. At step 1040, upon determining the amount of invoice to be sent to the member location 520, the invoice is prepared and submitted to the member location for payment. This invoice may be prepared by computer and then sent via electronic mail to the member location 520 provided contact e-mail address. Alternatively, the invoice may be sent to the member location 520 via regular mail.

Method 1000 then proceeds to step 1050. At step 1050 the member location 520 makes payment on the invoice within a time period provided. The time period provided may be fifteen days, thirty days, or some other time period. Alternatively, the amount of invoice may be automatically paid from a credit card of the member location 520 that is on file in the database 170 (FIG. 1). After step 1050, method 1000 proceed to step 1060 where method 1000 ends. Although some steps in method 1000 have been described above, certain steps may be performed in a different order, divided in to additional steps, merged into fewer steps, or altered to obtain the same or similar result without departing from the scope and spirit of the exemplary embodiments.

Although the invention is described with reference to preferred embodiments, it should be appreciated by those skilled in the art that various modifications are well within the scope of the invention. Therefore, the scope of the invention is to be determined by reference to the claims that follow. From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those or ordinary skill in the art, and ways of constructing other embodiments of the present invention will suggest themselves to practitioners of the art. Therefore, the scope of the present invention is to be limited only by any claims that follow.

We claim:

1. A computer-implemented method using a handheld device for facilitating a user of an application to interact face-to-face with another user of the application at a member location, comprising the steps of:
logging into an application from a handheld device having a display screen;
upon logging in to the application, transmitting user information to a database;
while using the application, travelling to a location where at least one member location appears on the display screen when the user is in a selected proximity to the at least one member location;
while using the application, entering into one of the member locations;
upon entering the member location, transmitting other user information that are using the application and which are present at the same member location as the user to the display screen;
while using the application, allowing information on other users that are using the application and which are present at the same member location as the user to appear on the display screen;
while using the application, communicating with at least one other user having information displayed on the display screen to determine whether the user and the at least one other user wants to meet and communicate face-to-face at the member location, the communicating being performed using the handheld device of the user and the handheld device of the at least one other user; and
physically meeting the at least one other user for a face-to-face meeting.

2. The computer-implemented method of claim 1, wherein logging into the application from the handheld device comprises verifying user login credentials at a login credentials site.

3. The computer-implemented method of claim 1, wherein logging into the application from the handheld device comprises verifying user login credentials, the user login credentials comprising a user name and a password.

4. The computer-implemented method of claim 1, further comprising leaving the member location.

5. The computer-implemented method of claim 4, wherein upon entering the member location, a timer is started.

6. The computer-implemented method of claim 5, wherein upon leaving the member location, the timer is stopped.

7. The computer-implemented method of claim 6, further comprising transmitting a timer data from the timer to the database.

8. The computer-implemented method of claim 1, wherein upon entering the member location, the user selects a user availability that is communicated to other users of the application in the member location.

9. The computer-implemented method of claim 8, wherein the user availability comprises an available and a busy.

10. The computer-implemented method of claim 1, wherein upon entering the member location, the user selects a user preference status that is communicated to other users of the application in the member location.

11. The computer-implemented method of claim 10, wherein the user preference status comprises a casual mingle and a business mingle.

12. The computer-implemented method of claim 1, wherein communicating with at least one other user having information displayed on the display screen comprising sending and receiving instant messages between the handheld device of the user and the handheld device of the other user within the application.

13. The computer-implemented method of claim 1, wherein a number of unread instant messages sent from another user is displayed on the display screen within the other user information.

14. A computer program product for facilitating a user to interact face-to-face with another user at a member location, comprising:
a computer-readable medium comprising:
a login module for allowing a user of the computer program product to provide user credentials and having the user credentials be verified to allow the user access to use one or more features of the computer program product;
a GPS/location map module for allowing the user to obtain a map for display on a display screen of a handheld device of the user;
a member location module for receiving information on one or more member locations and identifying the one or more member locations on the map;
a user location module for identifying and displaying a location of the user on the map, for updating the location of the user on the map when the user moves; and identifying and displaying other user information that are in a member location on the display screen when the user physically enters the member location;
a user information module for allowing the user to provide user information to be displayed to other users present in the same member location as the user; and
a messaging module for allowing the user to communicate with other users that are in the same member location to determine whether the user and the other user want to meet for a face-to face communication.

15. The computer program product of claim 14 further comprising a time data module for determining the amount of time the user was present within the member location.

16. The computer program product of claim 14, wherein the user information comprises at least one of a user availability and a user preference status.

17. The computer program product of claim 16, wherein the user availability comprises an available and a busy and the user preference status comprises a casual mingle and a business mingle.

18. A computer-implemented method for determining an invoice amount for a member location that allows a user to use a handheld device for facilitating the user of an application to interact face-to-face with another user of the application at the member location, comprising the steps of:
receiving, using a computer, a plurality of member location information for a member location;
receiving, using a computer, a time data, for each visit that each user visited the member location during the billing cycle, from a handheld device of each user, the time data providing information for determining a total time the user was present at the member location during each visit to the member location during the billing cycle;
determining a no charge time period for each user visit to the member location during the billing cycle;
determining, using a computer, a remaining time period, for each visit that each user visited the member location during the billing cycle, by subtracting the no charge time period from each of the total time the user was present at the member location during each visit to the member location during the billing cycle, the remaining time period being zero if calculated to be negative;
determining, using a computer, a user billed time period, for each user, by summing each of the determined remaining time periods for that user;
determining, using a computer, a user charge, for each user, by multiplying each of the user billed time periods by a value rate; and
determining, using a computer, an amount of invoice for the member location by summing each of the determined user charges.

19. The computer-implemented method of claim 18, wherein receiving the time data comprises determining a start time on the handheld device of a user when the user enters a member location, determining a stop time on the handheld device of the user when the user leaves the member location, determining the time data by subtracting the stop time from the start time.

20. The computer-implemented method of claim 18, wherein the no charge time period is zero minutes.
